(19) United States
(12) Patent Application Publication
(10) Pub. No.: US 2012/0234819 A1
(43) Pub. Date: Sep. 20, 2012

(54) MULTILAYER STRUCTURAL HEATING PANEL

(76) Inventor: Craig M. Berger, Stockbridge, MA (US)

(21) Appl. No.: 13/509,159

(22) PCT Filed: Nov. 15, 2010
(86) PCT No.: PCT/US2010/056647

§ 371 Date: May 10, 2012

Related U.S. Application Data
(60) Provisional application No. 61/261,137, filed on Nov. 13, 2009.

(51) Int. Cl. H05B 3/02

(52) U.S. Cl. 219/213

(57) ABSTRACT

A structural panel includes a layer having a pair of substantially planar spaced apart surfaces and a preselected adhesive material occupying volume of the layer. At least one heating element includes an electrically resistive material and is substantially encased within the adhesive layer between the pair of substantially planar spaced apart surfaces. A first substantially rigid skin has an inner surface thereof disposed on and secured to a first surface of the adhesive layer. A lightweight core layer has a first surface thereof disposed on and secured to an opposed second surface of the adhesive layer. A second substantially rigid skin has an inner surface disposed on and secured to an opposed second surface of the lightweight core layer.

This application is related to and claims priority from Provisional Patent Application Ser. No. 61/261,137 filed on Nov. 13, 2009.

### FIELD OF THE INVENTION

The instant invention relates, in general, to heating panels and, more particularly, this invention relates to a multilayer structural heating panel employing an electrically resistive heating element that is encased within a thermally conductive layer.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, electrically operable heating panels have been employed in some applications to replace or augment other conventional heat generating systems. For example, U.S. Pat. No. 6,834,159 issued to Schramm and U.S. Pat. No. 6,622,659 issued to Meisiek disclose electrically operable heating panels for an aircraft.

U.S. Utility patent application Ser. No. 11,374,917 filed on Mar. 14, 2006 by the applicant of this invention and owned by the assignee of the present invention provides a heating floor panel for transit vehicle that is designed to eliminate use of conventional baseboard electric heaters and augment operation of the roof mounted heating unit.

However, there is a further need for an improved electrically operable heating panel of a multilayer construction that can be particularly installed on a mass transit passenger vehicle.

### OBJECTS OF THE INVENTION

It is, therefore, one of the primary objects of the present invention to provide a multilayer structural heating panel containing an electrically resistive heating element.

Another object of the present invention is to provide a multilayer structural heating panel containing an electrically resistive heating element encased within a thermally conductive layer.

Yet another object of the present invention is to provide a multilayer structural heating panel containing an electrically resistive heating element encased within a thermally conductive layer that is then disposed on top of a thermally non-conductive layer.

A further object of the present invention is to provide a multilayer structural heating panel containing an electrically resistive heating element encased within a thermally conductive layer and sandwiched between a pair of skins.

Yet a further object of the present invention is to provide a multilayer structural heating panel containing an electrically resistive heating element and a temperature sensor in heat sensing contact with the electrically resistive heating element, both encased within a thermally conductive layer.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### SUMMARY OF THE INVENTION

The invention provides a structural panel comprising a pair of substantially planar spaced apart surfaces, a preselected adhesive material disposed between the pair of substantially planar spaced apart surfaces, and at least one heating element having an electrically resistive material and being disposed between the pair of substantially planar spaced apart surfaces, the heating element generating heat upon supply of electric power to it.

The invention also provides a structural panel comprising a layer having a pair of substantially planar spaced apart surfaces and a preselected adhesive material occupying volume of the layer. Thermally conductive particles are imbedded throughout volume of the adhesive layer. There is at least one heating element that includes an electrically resistive material and that is substantially encased within the adhesive layer between the pair of substantially planar spaced apart surfaces. A first substantially rigid skin is provided and has an inner surface thereof disposed on and secured to a first surface of the adhesive layer. A lightweight core layer has a first surface thereof disposed on and secured to an opposed second surface of the adhesive layer. The lightweight core layer includes thermally non-conductive material. There is also a second substantially rigid skin having an inner surface disposed on and secured to an opposed second surface of the lightweight core layer. A temperature sensor is provided in heat sensing contact with at least one of the heating element and the second skin, the temperature sensor being imbedded within at least the adhesive layer in close proximity to the second skin. A switch is operatively mounted between the at least one heating element and a power supply unit. The switch is imbedded within the adhesive layer. A controller is electrically connected to at least the temperature sensor for selectively supplying and discontinuing supply of power to the at least one heating element so as to maintain preselected temperature on the outer surface of the second skin of the panel. The controller executes a predetermined algorithm for maintaining consistent temperatures on the outer surface of the first skin and for minimizing ON/OFF switching of the at least one heating element.

### BRIEF DESCRIPTION OF THE DRAWINGS

FIG. 1 is a schematic representation of a transit vehicle;

FIG. 2 is a cross-sectional view of the transit vehicle along lines 2-2 of FIG. 1;

FIG. 3 is an exploded isometric view of a heating panel constructed in accordance with one form of the invention;

FIG. 4 is a partial end view of the heating panel of FIG. 3;

FIG. 5 is a planar view of the heating panel of FIG. 3;

FIG. 6 is an end view of the electrically resistive heating element employed within the heating panel of FIG. 3;

FIG. 7 is a partial cross-sectional view of a temperature sensor along lines VII-VII of FIG. 3;

FIG. 8 partial cross-sectional view of the heating panel along lines VIII-VIII of FIG. 3, particularly illustrating an auxiliary track employed within the heating panel;

FIG. 9 is a schematic representation of a control system for heating panel of FIG. 3;

FIG. 10 is an elevation view of the panel of FIG. 3;

FIG. 11 is a schematic representation of a phase control of the heating panel of FIG. 3; and

FIG. 12 is an end view of a heating panel constructed in accordance with another form of the invention

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a mass transit vehicle includes but not limited to locomotive, rail car, passenger rail vehicle, passenger transit bus, passenger utility bus, school bus, and utility vehicle.

The present invention describes a structural heating panel having plurality of layers bonded therebetween and further having means to heat air, by convection, radiation or conduction, in generally enclosed confines.

The instant invention is illustrated and described in combination with a mass transit rail vehicle 10, although it will be apparent to those skilled in the relevant art that the present invention may be applied to other vehicles or enclosed confines and as such should not be interpreted as a limiting factor of the multilayered panel 10 of the instant invention.

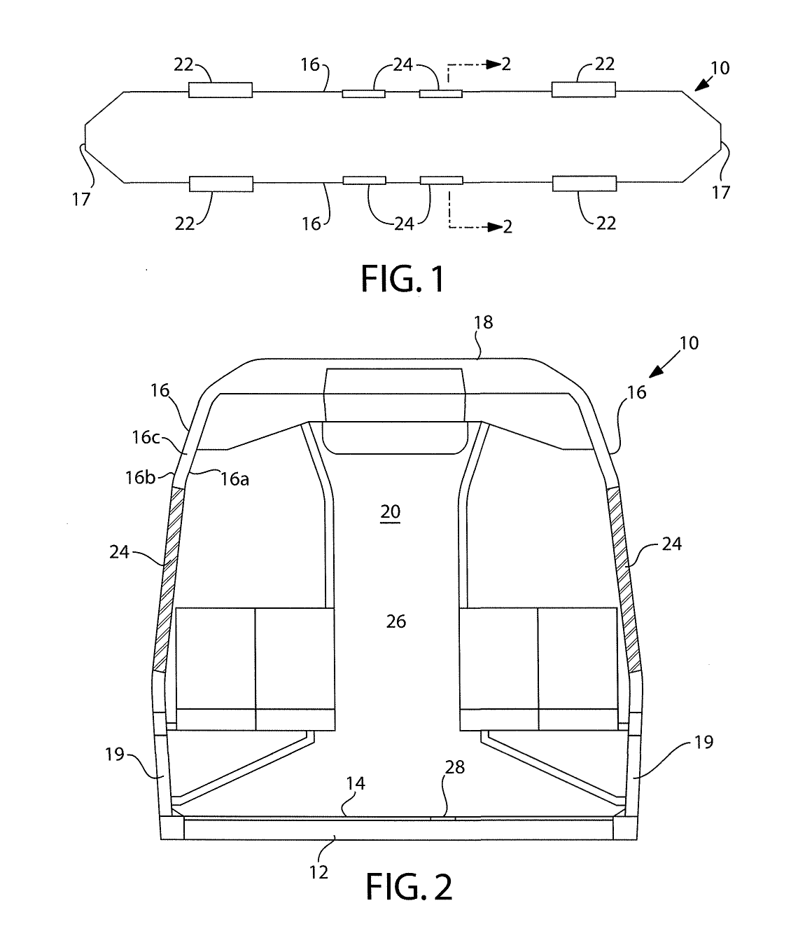

To help the user in understanding the environment in which the present invention will be used, the mass transit rail vehicle 10 is shown schematically in FIGS. 1-2. Such mass transit rail vehicle 10 is characterized by a sub-floor support structure 12, floor 14, pair of generally hollow side walls 16, pair of end walls 17 and a roof 18 defining a passenger compartment 20. Plurality of doors 22 are provided within each side wall 16 for enabling passenger ingress and egress. Plurality of windows 24 are further provided within each side wall 16 for passenger comfort and for enabling entry of the natural light into the passenger compartment 20. Plurality of seats 26 are generally positioned adjacent each side wall 16. An inner skin 16a and an outer skin 16b define a thickness 16c of the side wall 16. A floor cover 28, manufactured from carpet, engineered plastics, wood or elastomer, is applied over the floor 14 for passenger comfort and safety.

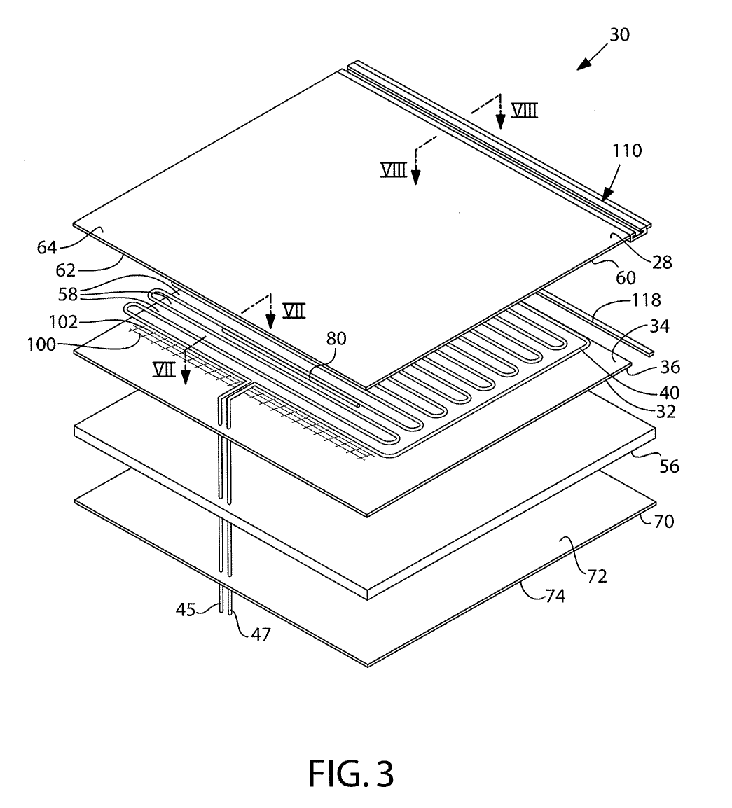

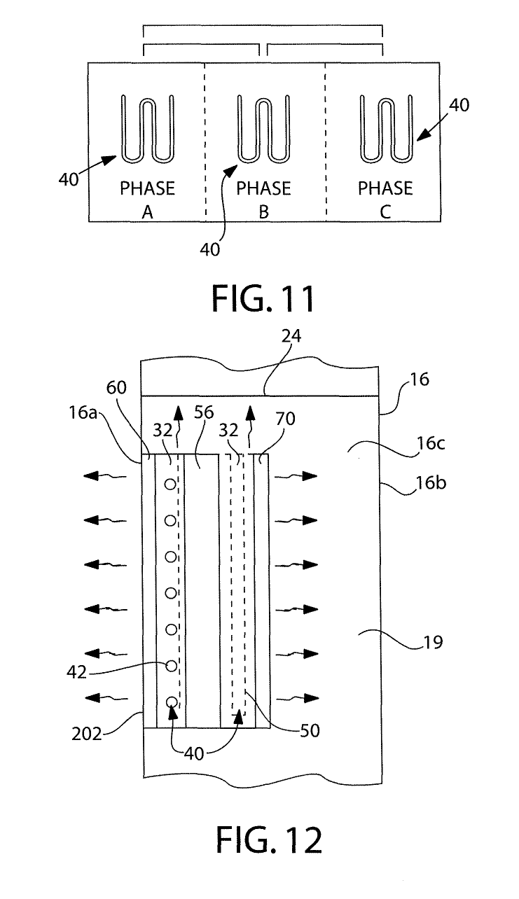

Now in reference to FIGS. 3-11 and in accordance with one form of the invention, a multilayer structural heating panel, generally designated as 30 and hereafter referred to as “panel 30”, is provided to essentially replace the conventional floor 14. Thus, the panel 30 is installed intermediate the floor covering 28 and the sub-floor support structure 12 and is fastened to the sub-floor structure 12.

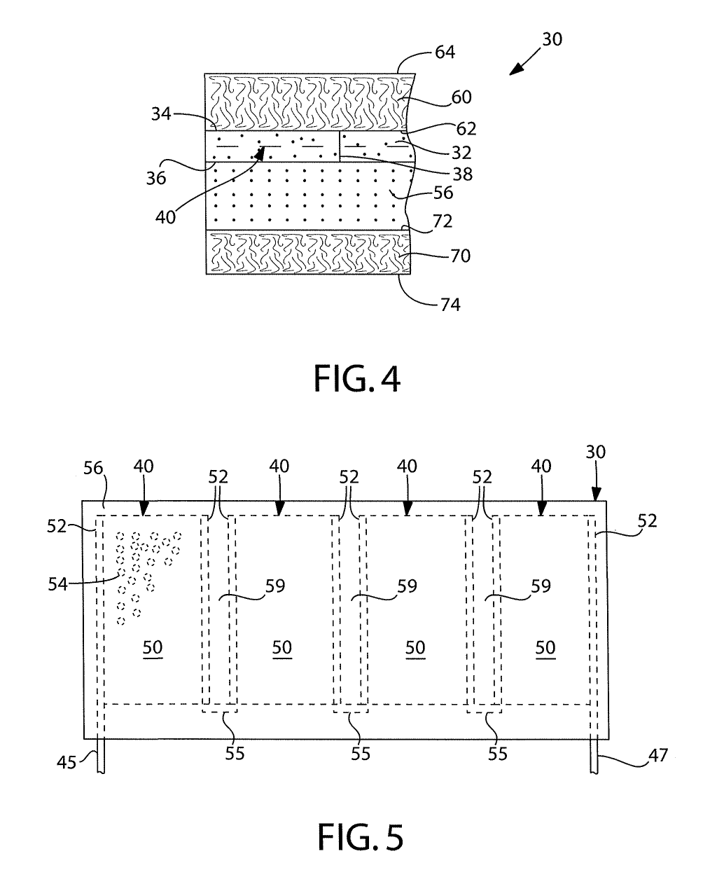

In a particular reference to FIGS. 3-4, the panel 30 includes a first layer 32 having a pair of substantially planar surfaces 34, 36 spaced apart to define substantially uniform thickness 38 of the first layer 32. In the present invention, the first layer 32 is provided by an adhesive material, for example such as an epoxy resin. Preferably, the layer 32 further includes thermally conductive particles, for example such as aluminum oxide, embedded throughout the volume of the layer 32 so as to provide thermally conductive layer 32 for the purposes to be explained later. The term “thermally conductive layer” will be construed thereafter to mean that the selected material of such layer 32 facilitates passage of heat therethrough in either lateral or transverse directions relative to surfaces 34, 36 of the thermally conductive layer 32.

There is also at least one heating element 40 being substantially encased within the layer 32 between the surfaces 34 and 36. The at least one heating element 40 is manufactured from an electrically resistive material. Such electrically resistive material may be a conventional metallic conductor (wire) element 42 disposed in a predetermined pattern, for example such as a serpentine pattern of FIG. 3, including series of U-turns. The at least one heating element 40 is a substantially planar element with the thickness of its plane defined by thickness of the wire 42.

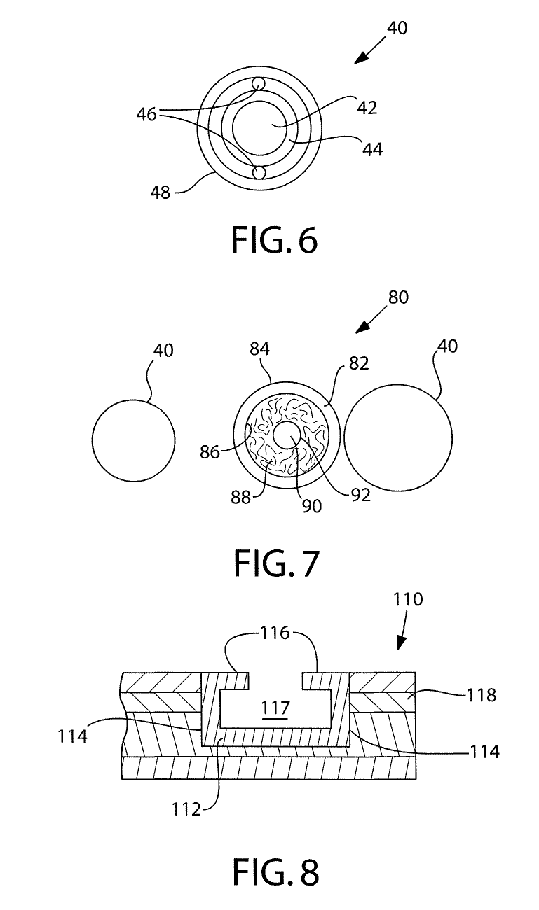

In further reference to FIG. 6, the metallic conductor (wire) element 42 is encased within an inner jacket 44. Furthermore, a pair of optional ground wires 46 may be positioned in abutting relationship with the outer surface of the inner jacket 44 for ground fault protection. An outer jacket 48, preferably manufactured from fluoropolymer or similar materials may be also provided.

To facilitate assembly of the panel 30, including conductor wire 42, so as to position such conductor wire 42 in a stable manner preventing movement thereof during assembly to maintain at least the peripheral border 56, a generally thin mesh member 100 is provided in abutting engagement with the exterior surface of the heating element 40 and is preferably at least temporarily secured thereto with an adhesive 102. Preferably, the mesh member 100 is manufactured from flexible and thermally non-conductive material such as nylon. The mesh member 100 is spaced by a small distance from the surface of the thermally conductive layer 32 but may also be flush therewith.

Such electrically resistive material of the at least one heating element 40 may also be a substantially planar and thin fiber-reinforced Polyethylene Terephthalate (PET) film 50 of FIG. 4, having electrically conductive copper contacts incorporated throughout the volume thereof. In combination with such film 50, the at least one heating element 40 further includes a pair of elongated electrical conductors 52 disposed along opposite edges of the film 50. The film 50 may include optional perforations 54 formed through thickness thereof. Preferably, the film 50 with electrical conductors 52 is of the type as manufactured by Frenzelit-Werke GmbH & Co. KG of Germany under HICOTEC® brand. The film 50 may be also of a Kapton type insulated heater or other like film materials.

The at least one heating element 40 may be provided as in series interconnected, series parallel or parallel configurations. In further reference to FIG. 5, employing plurality of films 50, such heating elements 40 are connected in series with jumpers 57. The at least one heating element 40 generates heat upon supply of electric power. The heat radiates through the layer 32 and, more particularly, radiates upwardly through the floor covering 28.

With employment of either wire 42 or the film 50, the panel 30 includes a peripheral border 56 where thickness of the panel 30 is essentially free from presence of such wire 42 or the film 50. One purpose of such border 56 is to allow the peripheral edges of the panel 30 to be machined or trimmed during installation, particularly in field retrofits of the vehicle 10. Another purpose of such border 56 is to prevent rubbing of the at least one heating element 40 with the structure of the vehicle 10, potentially causing shorting condition of the at least one heating element 40.

Furthermore, the panel 30 of FIG. 3, employing wire 42 arranged in a serpentine pattern, includes a plurality of elongated voids 58 disposed between a pair of adjacent legs of such serpentine pattern. Furthermore, when the panel 30 is adapted with films 50, as best shown in FIG. 5, there is a plurality of elongated voids 59 disposed between the adjacent edges of the pair of heating elements 40.

Therefore, the panel 30 employing the thermo-conductive layer 32 promulgates heat distribution throughout the surface of the panel 30, thus heating the areas occupied by peripheral border 56 and voids 58 and/or 59.

It has been determined that sizing the heating element 40 so as to not exceed a power output of fifty (50) Watt per square foot is suitable for most if not all applications in order to generate a temperature of no more than one hundred forty five degrees Fahrenheit (145 F.) as is currently mandated by the regulations.

In further reference to FIGS. 3-4, the panel 30 may also include a lightweight core layer 56 disposed between the layer 32 having the at least one heating element 40 disposed therewithin and the sub-floor support structure 12. Preferably, such lightweight core layer 56 is a thermally non-conductive layer. The term “thermally non-conductive layer” will be construed thereafter to mean that the selected material of such layer 56 restricts or substantially eliminates passage of heat therethrough in either lateral or transverse directions relative to surfaces of the thermally non-conductive layer 56. The presently preferred material of the thermally non-conductive layer 56 is syntactic foam essentially comprised of hollow glass spheres held together by an adhesive, for example such as an epoxy resin. The syntactic foam has been found resistant to heat within acceptable limits of applications.

The panel 30 may further include a first exterior skin 60 having an inner surface 62 thereof disposed on and secured to the surface 34 of the layer 32 and facing the at least one heating element 40 and further having an outer surface 64 thereof abuttingly engaging an inner surface of the floor covering 28. The first skin 60 is substantially rigid and is preferably manufactured from a fiberglass material or any other fiber-based materials, but may be also manufactured from different materials, for example such as metal.

Equally as well, the panel 30 may also include a second skin 70 having inner surface 72 thereof thereof disposed on and secured to the layer 56 and having an outer surface 74 thereof abuttingly engaging upper surface of sub-floor support structure 12. Preferably, the second skin 70 is also manufactured from a fiberglass material or any other fiber-based materials, but may be also manufactured from different materials, for example such as metal. The skins 60 and 70 may have identical or different thicknesses.

The above described panel 30 is characterized by impact resistance, steady state compressive load, and light weight. When the panel 30 is employed as the floor 14 of the vehicle 10, the above described structure of such panel 30 is adapted to withstand rigors of mass transit environment related mostly to interior structures and passenger traffic and as specified by various loading conditions (factors) depending on the design and use of the vehicle 10.

The construction of the panel 30 facilitates inclusion of the at least one track 110 for attachment of seats, stantions, side panels and other components normally found within the passenger compartment 20 of the mass transit rail vehicle 10. As best shown in FIG. 8, the track 110 may include a base portion 112, pair of upstanding walls 114 and a pair of inwardly disposed flanges 116 defining a hollow interior 117. A filler 118 may be also provided to fill any voids and complete the thickness of the panel 30. Both the track 110 and the filler 118 are preferably integrated into the panel 30 during assembly thereof.

The panels 30 may be also provided with the floor covering 28 secured in a generally permanent or semi-permanent manner to the outer surface 64 of the first skin 60.

A temperature sensor 80 is provided for controlling operation of the at least one heating element 80. It is presently preferred to position such temperature sensor 80 in close proximity to the first (top) skin 60, so as to sense the surface temperature of such first skin 60 or extrapolate the surface temperature of such first skin 60 through a predetermined control algorithm at least based on materials and thicknesses of first skin 60 and layer 32. The temperature sensor 80 may be further provided in heat sensing contact with the at least one heating element 40. According to one form of the invention, the temperature sensor 80 is a thermistor or the like devices. In accordance with another form of the invention, such temperature sensor 80 may be provided as a thermal well 82 having an exterior surface 84 thereof being in abutting engagement with an exterior surface of the at least one heating element 40, a thermal transfer medium 88 disposed within an interior hollow portion 86 of the thermal well 82 and a thermocouple 90 having heat sensing portion 92 thereof encased within the thermal transfer medium 88. The use of the thermal well 82 affords ease of replacing temperature sensor 80. In either form, the temperature sensor 80 is embedded within the layer 32 being disposed between paced apart surfaces 34, 36 thereof. Thus, when the panel 30 is provided without the first skin 60, the imbedded temperature sensor 80 affords sensing surface temperature of such layer 32.

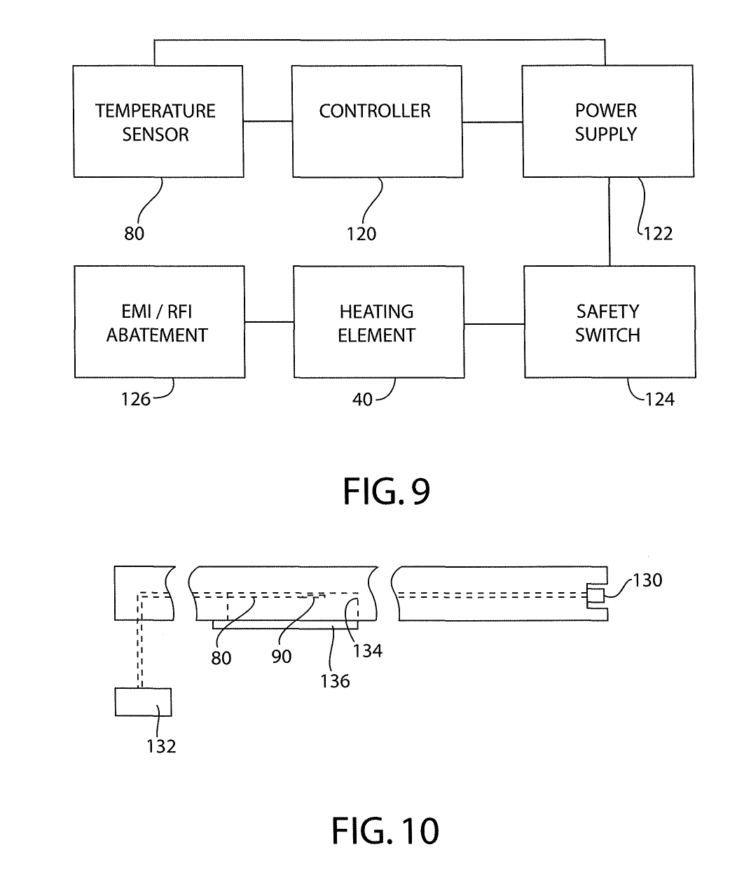

In further reference to FIG. 9, a controller or control circuit 120 is provided and is electrically connected to at least the temperature sensor 80 for selectively supplying and discontinuing supply of power from the power supply unit 122 to the heating element 40 so as to maintain preselected temperature on the outer surface 64 of the first skin 60 of the panel 30. An optional safety switch 124 is preferably imbedded within the panel 30, in series with the heating element 40, and is designed to trip at a preset temperature value and discontinue supply of power from the power supply 122 to the heating element 40 during an overtemperature condition.

Yet in further reference to FIG. 9, panel 30 includes means 126, preferably encased therewithin to abate emissions of electromagnetic interference (EMI) and/or radio frequency interference (RFI) generated during operation of the panel 30. Such abatement means 126 may be a filter.

It has been found advantageous, in order to maintain a preselected consistent temperature on the outer surface 64 of the first skin 60 and operate the at least one heating element 40 in a steady state mode by substantially minimizing ON/OFF switching of the at least one heating element 40, to provide means within the controller or control circuit 120, responsive to received temperature reading values from the temperature sensor 80, for executing an algorithm that is based on integral cycle (zero-cross voltage switching) control mode and is preferably based on the phase-angle or pulse-width-modulation (PWM) control mode. For example, a solid state contactor manufactured by Power-IO, Inc of Naperville, Ill. under RSDA model may be used in the instant invention. Now in a particular reference to FIG. 10, to connect the at least one heating element 40 to the power supply 122, as well as to connect the temperature sensor 80 to the controller or control circuit 120, the instant invention contemplates any one of the terminal strip 130 mounted either on the side or bottom of the panel 30, a junction box 132 mounted on or extending from the bottom of the panel 30 and preselected length of the wires 45, 47 extending beyond the boundary of the panel 30. A cavity 134 may be provided within the bottom portion of the panel 30 for replacing the thermocouple 90. The cavity 134 may be adapted with a removable cover 136.

The panel 30 may be configured for a single phase or three phase power distribution. In either phase, it is contemplated that more than one heating element 40 can be embedded within the panel 30 to provide proper power output and/or create distinct heating zones. For example, higher heat output is generally required in the floor areas adjacent to the doors 22, while lower heat output may be required within the passenger compartment 20 between the doors 22 disposed within the same side wall 16.

At least a pair of heating elements 40 may be provided to improve reliability of the panel 30 during operation should one heating element 40 fail either due to internal or external factors.

In the most preferred embodiment, the panel 30 is manufactured in accordance with the following process. First, a hollow mold is provided. Then, a first (top) skin 60 is placed into the bottom of the mold in partially (semi) cured form providing a tacky upper surface. Next, heating element 40, either alone or combination is positioned in a particular configuration on the inner surface 62 of the first skin 60. Adhesive layer 32 is poured. Then, lightweight core layer 56 (syntactic foam) is poured in liquid form. Heat is applied to both top and bottom surfaces of the mold and pressure is applied to the top surface thereof in order to partially cure the panel 30 for a predetermined period of time. During application of heat and pressure, the adhesive of the layer 32 flows under and around the heating element 40, thus substantially encasing the heating element 40 within the thickness of the layer 32. Finally, the second skin 70 is placed in partially (semi) cured form onto the top surface of the lightweight core layer 56 and heat and pressure are reapplied to completely cure the panel 30. After the panel 30 is completely cured, application of heat and pressure is removed and the panel 30 is allowed to cool at room temperatures.

The instant invention also contemplates that in its basic form, the panel 30 may be provided as only having the layer 32, with or without the heat conducting particles, and the at least one heating element 40 encased therewithin, thus only the layer 32 may be at least partially cured within the mold. Equally as well, the panel 30 may be provided with only the lightweight core layer 56 in combination with the layer 32 and may be provided with the lightweight core layer 56 and only one skin 60 or 70 in combination with the layer 32, wherein the layer 32 includes the at least one heating element 40 disposed between the surfaces 34, 26 thereof. Furthermore, the temperature sensor alone or in combination with the safety switch 124 and further in combination with the EMI/RFI abatement means 126 may be further provided within the layer 32.

The panel 30 may be also mounted within the hollow side wall 16 particularly in its portion 19 below the windows 24, so that the outer surface 63 of the first skin 60 is positioned generally planar with the inner surface 16a of generally hollow side wall 16.

Now in a particular reference to FIG. 12 and in accordance with another form of the invention, a heating panel 200 is provided and has an inner surface 202 thereof positioned generally planar with the inner surface 16a of generally hollow side wall 16, particularly in its portion 19 below the windows 24.

The heating panel 200 may be substantially identical to the above-described panel 30 but may be also provided with a second thermally conductive layer 32 and a second heating element 40, both being disposed on the opposite surface of the thermally non-conductive layer 56. In this arrangement, the panel 200 is also advantageous for heating the hollow interior of the wall 16 for window pane defrosting purposes. The panel 200 may include a pair of conductor wires 42, a pair of films 50 or a combination of the conductor wire 42 and film 50 as shown in FIG. 12.

Although the present invention has been shown in terms of the panel 30 or 200 being installed within the mass transit vehicle 10, it will be apparent to those skilled in the art, that either panel 30 or 200 may be installed in residential dwellings or used in other applications.

It is further important to note that use of the panel 30 or 200 must accommodate for thermal expansion and contraction by employment of predetermined gaps between opposed edges of the adjacent panels 30 or 200.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. A structural panel comprising:
(a) a pair of substantially planar spaced apart surfaces;
(b) a preselected adhesive material disposed between said pair of substantially planar spaced apart surfaces;
(c) at least one heating element including an electrically resistive material and being disposed between said pair of substantially planar spaced apart surfaces, said heating element generating heat upon supply of electric power to it; and
(d) a temperature sensor disposed within said adhesive layer between said substantially planar spaced apart surfaces thereof.

2. (canceled)

3. A structural panel comprising:
(a) a layer having a pair of substantially planar spaced apart surfaces and a preselected adhesive material occupying volume of said layer;
(b) at least one heating element including an electrically resistive material and being substantially encased within said adhesive layer between said pair of substantially planar spaced apart surfaces;
(c) a first skin having an inner surface thereof disposed on and secured to a first surface of said adhesive layer;
(d) a lightweight core layer having a first surface thereof disposed on and secured to an opposed second surface of said adhesive layer; and
(e) a second skin having an inner surface thereof disposed on and secured to an opposed second surface of said lightweight core layer, said second skin being substantially rigid.

4. The panel, according to claim 3, wherein said panel includes a temperature sensor being in heat sensing contact with at least one of said at least one heating element and said first skin.

5. The panel, according to claim 4, wherein said temperature sensor is disposed within said adhesive layer between said substantially planar spaced apart surfaces thereof.

6. The panel, according to claim 4, wherein said panel includes a controller being electrically connected to each of a temperature sensor and a power supply unit, said controller responsive to temperature value inputs from said temperature sensor for selectively supplying and discontinuing supply of power to said at least one heating element, whereby a preselected substantially consistent temperature is maintained on said outer surface of said first skin of said panel.

7. The panel, according to claim 3, wherein said electrically resistive material is a metallic wire arranged in a predetermined pattern.

8. The panel, according to claim 7, wherein said wire includes an insulating jacket and wherein said panel further includes each of a thermal well being in abutting engagement with an exterior surface of said insulating jacket, a thermal transfer medium disposed within an interior hollow portion of said thermal well and a thermocouple having heat sensing portion thereof encased within said thermal transfer medium.

9. The panel, according to claim 8, wherein said panel includes a mesh being in abutting engagement with an exterior surface of said insulating jacket.

10. The panel, according to claim 9, wherein said mesh member is secured to said insulating jacket.

11. The panel, according to claim 9, wherein said mesh member is disposed on or in close proximity to said adhesive layer.

12. The panel, according to claim 3, wherein said electrically resistive material is a fiber-reinforced Polyethylene Terephthalate (PET) film having electrically conductive contacts incorporated throughout volume thereof and wherein said at least one heating element further includes pair of elongated electrical conductors disposed along opposite edges of said film.

13. The panel, according to claim 12, wherein said film includes perforations formed through thickness thereof.

14. The panel, according to claim 3, wherein said panel includes at least one track having a hollow interior.

15. The panel, according to claim 3, wherein said panel includes thermally conductive particles imbedded throughout volume of said adhesive layer.

16. The panel, according to claim 3, wherein said lightweight core layer includes a thermally non-conductive material.

17. The panel, according to claim 16, wherein said thermally non-conductive material is a syntactic foam.

18. A structural panel comprising:
(a) a layer having a pair of substantially planar spaced apart surfaces and a preselected adhesive material occupying volume of said layer;
(b) thermally conductive particles imbedded throughout volume of said adhesive layer;
(c) at least one heating element including an electrically resistive material and being substantially encased within said adhesive layer between said pair of substantially planar spaced apart surfaces;
(d) a first substantially rigid skin having an inner surface thereof disposed on and secured to a first surface of said adhesive layer;
(e) a lightweight core layer having a first surface thereof disposed on and secured to an opposed second surface of said adhesive layer, said lightweight core layer including thermally non-conductive material;
(f) a second substantially rigid skin having an inner surface disposed on and secured to an opposed second surface of said lightweight core layer;
(g) a temperature sensor being in heat sensing contact with at least one of said heating element and said first skin, said temperature sensor being disposed between said spaced apart surfaces of said adhesive layer in close proximity to said first skin;
(h) a switch operatively mounted between said at least one heating element and a power supply unit, said switch disposed within said adhesive layer between said pair of substantially planar spaced apart surfaces thereof; and
(i) a controller being electrically connected to at least said temperature sensor for selectively supplying and discontinuing supply of power to said at least one heating element so as to maintain preselected temperature on said outer surface of said first skin of said panel, said controller executing a predetermined algorithm in response to temperature value inputs from said temperature sensor, whereby a preselected substantially consistent temperature is maintained on said outer surface of said first skin and whereby said at least one heating element is operable in a steady state mode.

19. The panel of claim 18, further including a peripheral boarder region that is essentially free of said at least one heating element.

20. In combination with a floor of a mass transit vehicle, said floor having at least a floor covering and a support structure, a panel disposed intermediate said floor covering and said support structure, said panel comprising:
(a) a member secured to said support structure and having a pair of substantially planar spaced apart surfaces and a preselected adhesive material occupying volume of said member; and
(b) at least one heating element including an electrically resistive material and being substantially encased within said member between said pair of substantially planar spaced apart surfaces, said heating element generating heat upon supply of electric power to it, said heat radiating through said floor covering.

21. The panel, according to claim 20, wherein said panel includes a thermally non-conductive layer disposed between said member and said support structure.

22. The panel, according to claim 20, wherein said panel includes a rigid skin having an inner surface thereof disposed on and secured to said member, wherein said floor covering is secured to an outer surface of said skin.
